(19) United States
(12) Patent Application Publication
(10) Pub. No.: US 2019/0300827 A1
(43) Pub. Date: Oct. 3, 2019

(54) Beer Brewing Device, Brewing Process Thereof, And its boil and fermentation module

(71) Applicant: Szuma Liang, Hsinchu City (TW)

(72) Inventor: Szuma Liang, Hsinchu City (TW)

(21) Appl. No.: 16/361,052

(22) Filed: Mar. 21, 2019

(30) Foreign Application Priority Data
Mar. 27, 2018 (TW) 107110520

(51) Int. Cl. C12C 11/00; C12C 7/06; C12C 7/20; C12C 7/26

(52) U.S. Cl. CPC C12C 11/006; C12C 7/06; C12C 13/00; C12C 7/26; C12C 7/205

(57) ABSTRACT

A beer brewing device comprises: a mashing module, a boil and fermentation module, and a temperature control module. The boil and fermentation module is assembled with the mashing module in a swappable manner. The temperature control module controls the temperature of the beer brewing process. The boil and fermentation module can be detached from the mashing module during the fermentation process or after the beer brewing process is completed, such that another boil and fermentation module can be connected with the mashing module to perform another beer brewing process. In addition, the beer brewing device also has the advantages of automatic high-temperature cleaning and sterilization functions, two fermentation processes in one tank, and integrated and automatic brewing process.

### BACKGROUND OF INVENTION

### 1. Field of the Invention

The invention refers to a beer brewing device, especially refers to a beer brewing device which comprises a boil and fermentation module for performing two fermentation processes in one tank, in addition, the boil and fermentation module can be detached and replaced by another boil and fermentation module in order to perform another beer brewing process.

### 2. Description of the Prior Art

The process of making beer is called brewing, which can be performed in a family workshop or an industrial brewery. Non-profit beer brewing is generally called home brewing. Brewing beer is subject to national legislation and taxation.

The first step of brewing is the saccharification of starch (known as “mashing”). In this step, the starch source (normally malted barley) is mixed with hot water, which is known as “wort”. Hot water is mixed with crushed malt or malts (known as “grist”) in a mashing tank. The mixture of hot water and grist was kept in the mashing tank for around one to two hours in the mashing process, during which the starches are converted to sugars, and then the sweet wort is drained off the malt grains. The malt grains are then washed in a process known as “sparging”. This washing allows the brewer to gather as much of the fermentable liquid from the malt grains as possible. The process of filtering the spent malt grains from the wort and sparge water is called wort separation. The traditional process for wort separation is lautering, in which the shells of crushed malts serve as the filter medium. Some modern breweries prefer the use of frame-typed pressure filters in order to increase productivity. These modern breweries use a continuous producing process to wash the malt grains, collecting the original wort and the sparge water together. However, it is possible to collect a second or even third wash with the not quite spent grains as separate batches. Each run would produce a weaker wort and thus a weaker beer. This process is known as second (and third) runnings. Brewing with several runnings is called “parti-gyle brewing”.

The sweet wort collected from sparging is put into a container, called “copper vessel” (so called because these vessels were traditionally made from copper), and boiled, usually for about one hour. During boiling, water in the wort evaporates, but the sugars and other components of the wort remain; this allows more efficient use of the starch sources in the beer. Boiling also destroys any remaining enzymes left over from the mashing stage. Hops are added during boiling as a source of bitterness, flavour and aroma. Hops may be added at more than one point during the boil. The longer the hops are boiled, the more bitterness they contribute, but the less hop flavour and aroma remains in the beer.

After boiling, the hopped wort is cooled, and then the yeast is added. In some breweries, the hopped wort may pass through a hopback, which is a small vat filled with hops, to add aromatic hop flavouring and to act as a filter; but usually the hopped wort is simply cooled for the fermenter, where the yeast is added. During fermentation, the wort becomes beer in a process which requires a week to months depending on the type of yeast and strength of the beer. In addition to producing ethanol, fine particulate matter suspended in the wort settles during fermentation. Once fermentation is complete, the yeast also settles, leaving the beer clear.

Although traditional brewing methods can make beers with various flavors, they still have the following deficiencies:

1. the brewing equipment is large in size, not easy to be customized and installed in restaurants, and is not suitable for small commercial brewers or homemade brewers;

2. lack of automatic control system, manual control of brewing parameters is required to control brewing quality; and

3. lack of automatic cleaning and sterilization functions, not easy to be cleaned.

Therefore, the objective of the present invention is to provide an automatic intelligent beer brewing equipment, which allows the restaurants, convenience stores, and family individuals to complete the brewing of craft beer simply in one click. The automatic intelligent beer brewing equipment of the invention comprises the following advantages:

1. integrated brewing process, reduced size, and fully automatic control;

2. high-temperature automatic cleaning and complete sterilization to the tanks and all pipelines;

3. cyclic sparging to gather as much fermentable sweet wort as possible;

4. controlling the fermentation process with water flow and constant temperature in order to monitor fermentation in real time so as to ensure consistent brewing quality; and

5. fully automatic two fermentation processes in one single tank, brewing craft beer that retains the rich taste of beer.

### SUMMARY OF THE INVENTION

The primary objective of the invention is to provide a beer brewing device, wherein a boil and fermentation tank can be detached and replaced by another one in order to perform another beer brewing process. The beer brewing device not only can brew beer more efficiently, but also can perform two fermentation processes in one single tank, as well as to brew craft beer that retains rich tastes after fermentation.

In order to achieve the aforementioned objective, the present invention provides a beer brewing device for performing a beer brewing process, said beer brewing device comprising:

a mashing module, comprising a mashing tank and a receiving compartment located below the mashing tank; the mashing tank having an opening and being capable of performing a mashing process of the beer brewing process;

a cover module, comprising a cover; the cover is pivotally covered on the mashing module in an openable manner, in order to close or open the opening of the mashing tank;

a boil and fermentation module, comprising a boil and fermentation tank connectable with the mashing tank; the boil and fermentation tank being capable of performing a boiling process and at least one fermentation process of the beer brewing process;

a temperature control module, connecting to the mashing module and the boil and fermentation module; the temperature control module comprising: at least one temperature controller and at least one at least one temperature controlling pipe; the at least one temperature controller being connected with the mashing tank and the boil and fermentation tank via the at least one temperature controlling pipe, in order to control a mashing temperature of the mashing process performed in the mashing tank, a boiling temperature of the boiling process performed in the boil and fermentation tank, and a fermentation temperature of the fermentation process performed in the same boil and fermentation tank; and

a pumping module, at least comprising a plurality of pipes and a plurality of valves and pumps located at the pipes; the pumping module is for connecting the mashing module, the cover module, the boil and fermentation module and the temperature control module, in order to pump at least a fluid to and between the mashing module and the boil and fermentation module.

In a preferred embodiment:

the boil and fermentation module is received in the receiving compartment of the mashing module in a detachable and replaceable manner; wherein, the boil and fermentation module can be individually detached and separated from the receiving compartment of the mashing module during the fermentation process or after the beer brewing process is completed, so as to insert another said boil and fermentation module into the receiving compartment of the mashing module for performing another said beer brewing process;

the mashing module further comprises: a yeast box, at least one hops box and a sugar box for containing yeast, hops and sugar required in the beer brewing process; a starch source can be put into the mashing tank through the opening;

an outlet end is located at a bottom of the mashing tank that is connectable with an opening end of the boil and fermentation tank, such that the fluid contained in the boil and fermentation tank can flow into the mashing tank through the opening end and the outlet end;

said at least one fermentation process comprises a first fermentation process and a second fermentation process;

said pipes of the pumping module comprises a first pipe and a second pipe; the first pipe connects with the mashing tank and upper ends of the yeast box, the at least one hops box, and the sugar box via the cover module; the second pipe at least connects with the boil and fermentation tank and bottom ends of the yeast box, the at least one hops box and the sugar box; by using the valves and the pumps, the fluid contained in the mashing tank can be drained to the boil and fermentation tank when the mashing process is completed, in addition, at least one of the yeast, hops and sugar can be fed into the boil and fermentation tank for performing either the boil process or the fermentation process;

said pipes of the pumping module further comprises a third pipe and a fourth pipe; the third pipe connects with the outlet end of the mashing module and the first pipe; the fourth pipe connects with the mashing tank, the first pipe and the third pipe; by using the valves and the pumps, the fluid contained in the boil and fermentation tank can be pumped back to the mashing tank when the first fermentation process is completed, and then, hot water can be fed to the boil and fermentation tank via the first pipe and the fourth pipe in order to perform a cleaning process, and then, the fluid contained in the mashing tank can once again be drained to the boil and fermentation tank for performing the second fermentation process.

In a preferred embodiment, the beer brewing device further comprises a water tank module; wherein, the water tank module comprises: a water tank, an oxygen tank and a carbon dioxide tank; the water tank is connected with the first pipe through a sixth pipe; the oxygen tank and the carbon dioxide tank are connected with the first pipe via a fifth pipe; oxygen contained in the oxygen tank and carbon dioxide contained in the carbon dioxide tank can be fed into the boil and fermentation tank via the mashing tank.

In a preferred embodiment:

the temperature controller is a heating/cooling module; the starch source includes a malted barley pack containing crushed malts;

the outlet end of the mashing module is equipped with a color detector, a particle detector and a drain valve; in addition, the pumping module further comprises: a plurality of sub-pipes, a plurality of temperature meters and at least one flow meter; wherein, the valves, the pumps, the temperature meters and the flow meter are equipped at predetermined locations of the pipes and sub-pipes respectively;

the mashing module further comprises a first detecting module and a second detecting module; wherein, the first detecting module comprises a first pressure meter, a first upper level temperature meter and a first lower level temperature meter for detecting the pressure and temperature inside the mashing tank respectively; the second detecting module comprises a bacteria meter, an alcohol meter, a bitterness meter, a sweetness meter, a level instrument, a second pressure meter, a second upper level temperature meter and a second lower level temperature meter for detecting related parameters inside the boil and fermentation tank;

a filter is equipped in the mashing tank;

an annular heater is equipped in the boil and fermentation tank;

the boil and fermentation module further comprises a one-way pressure valve for discharging carbon dioxide generated during the first fermentation process; the one-way pressure valve is closed during the second fermentation process so as to retain the carbon dioxide generated during the second fermentation process inside the boil and fermentation module.

In a preferred embodiment:

the pumps of the pumping module includes a mixing pump and a first pump; wherein, the mixing pump is located at the fourth pipe, while the first pump is located at the temperature controlling pipe;

the temperature control module further comprises a heater located at the first pipe;

the boil and fermentation module further comprises a communication tube for connecting between the mashing tank and the boil and fermentation tank; the communication tube is equipped with a valve;

the pumping module further comprises: a plurality of air valves and an air sub-pipe; wherein, the air valves are respectively located at predetermined locations of the first pipe and the fifth pipe in order to control passages of air, oxygen and/or carbon dioxide; the air sub-pipe are connected with the first pipe and the second pipe; the air sub-pipe can be used to supply compressed air or mixed air to the boil and fermentation tank through the second pipe only when the cover is tightly clamped with the mashing module.

In a preferred embodiment:

the cover can be tightly clamped with the mashing module by using a first clamp; the boil and fermentation module can be tightly fastened to the outlet end by using a second clamp so as to be received within the receiving compartment of the mashing module;

the boil and fermentation tank is located under the mashing tank and can be connected to the mashing tank in a detachable manner by using a rapid fastener.

In order to achieve the aforementioned objective, the present invention also discloses a beer brewing process of a beer brewing device, comprising steps of:

Step (1): providing a beer brewing device; the beer brewing device comprising a mashing module, a cover module, a boil and fermentation module, a temperature control module and a pumping module; the cover module covering the mashing module; the mashing module comprising a mashing tank; the boil and fermentation module comprising a boil and fermentation tank connectable with the mashing tank; the temperature control module being connected with the boil and fermentation module for controlling temperature;

Step (2): feeding of ingredients; the ingredients comprising a malted barley pack, a yeast, hops and sugar are placed into a plurality of boxes of the beer brewing device respectively;

Step (3): mashing and draining of sweet wort to the boil and fermentation tank; firstly, the pumping module feeding water heated by the temperature control module into the mashing tank; the water in the mashing tank being heated and maintained at a first temperature for a first period of time in order to facilitate a mashing process so as to generate the sweet wort; after the mashing process being completed, the sweet wort inside the mashing tank being filtered and drained to the boil and fermentation tank;

Step (4): boiling the sweet wort in the boil and fermentation tank and feeding the hops; the fluid in the boil and fermentation tank being heated to a second temperature for a second period of time, and the hops are added to the boil and fermentation tank at a predetermined timing; the second temperature is for boiling the sweet wort;

Step (5): cooling the boiled sweet wort and draining precipitates in the boil and fermentation tank; the boiled sweet wort inside the boil and fermentation tank being cooled down to a third temperature, and precipitates precipitated at bottom of the sweet wort being drained out from the boil and fermentation tank;

Step (6): first fermentation of the sweet wort with yeast added in the boil and fermentation tank; the yeast being added into the boil and fermentation tank, and then, the sweet wort added with the yeast being maintained at the third temperature for a third period of time, in order to perform a first fermentation process;

Step (7): reversed pouring of sweet wort; said Step (7) further comprising the following Step (7.1) to Step (7.5):

Step (7.1): cleaning the mashing tank with hot water;

Step (7.2): pumping the sweet wort contained in the boil and fermentation tank back to the mashing tank by using the pumping module;

Step (7.3): cleaning the boil and fermentation tank with hot water;

Step (7.4): draining the sweet wort contained in the mashing tank to the cleaned boil and fermentation tank;

Step (7.5): cooling the sweet wort contained in the boil and fermentation tank to the third temperature;

Step (8): second fermentation of the sweet wort in the boil and fermentation tank; the f sweet wort being maintained at the third temperature for a fourth period of time, in order to perform a second fermentation process; carbon dioxide generated during the second fermentation process being retained inside the boil and fermentation tank; after the second fermentation process being completed, fluid contained in the boil and fermentation tank becomes drinkable beer.

In a preferred embodiment:

in the Step (2), sugar is placed in one of the boxes;

in the Step (3), the first temperature is between 60° C. to 75° C., and the first period of time is ranged between one to three hours; in addition, during the mashing process, fluid inside the mashing tank is pumped by the pumping module to continuously cyclic flow through the temperature control module, such that the temperature of the fluid inside the mashing tank can be maintained at the first temperature to proceed with the mashing process;

in the Step (4), the second temperature is around 100° C., the second period of time is between one to three hours, the predetermined timing for adding the hops is during the second period of time;

in the Step (5), the third temperature is between 22° C. to 35° C.;

in the Step (6), the third period of time is ranged from 14 to 28 days; in addition, the carbon dioxide generated during the first fermentation process is discharged out of the boil and fermentation tank via an one-way pressure valve;

in the Step (7), temperature of said hot water for cleaning is over 70° C.;

in the Step (7.5), the sugar is added to the boil and fermentation tank;

in the Step (8), the fourth period of time is ranged from 4 to 10 days.

In a preferred embodiment:

a step for cleaning and sterilizing of the beer brewing device is included between the Step (1) and the Step (2) in order to clean and sterilize the mashing tank, the boil and fermentation tank, the boxes and a plurality of pipes of the pumping module;

a sparging step is included between the Step (3) and the Step (3) in order to feed a suitable amount of water at the first temperature into the mashing tank, and then the mashing tank is pressurized to drain the fluid into the boil and fermentation tank; wherein, the malted barley pack can be taken out of the mashing tank at anytime after the sparging process is completed and before the reversed pouring step (i.e., step (7)) begins.

In a preferred embodiment, the boil and fermentation module is connected to a receiving compartment of the mashing module in a detachable and replaceable manner; the boil and fermentation module can be detached and separated from the mashing module after the Step (5) is completed such that the boil and fermentation module can individually perform the first fermentation process of the Step (6); in addition, the boil and fermentation module can also be detached and separated from the mashing module after the Step (7) is completed such that the boil and fermentation module can individually perform the second fermentation process of the Step (8); therefore, when one said boil and fermentation module is separated from the mashing module for individually performing the fermentation process, another said boil and fermentation module can be connected to the mashing module for performing another said beer brewing process.

In order to achieve the aforementioned objective, the present invention also discloses a boil and fermentation module of a beer brewing device, the beer brewing device being for performing a beer brewing process; said boil and fermentation module comprising:

a boil and fermentation tank; said boil and fermentation tank being capable of containing a fluid for performing a boiling process and at least one fermentation process of the beer brewing process;

a temperature control module, connecting to the boil and fermentation tank and comprising: at least one temperature controller and at least one temperature controlling pipe; the temperature controller comprising a heating/cooling module; the temperature controlling pipe comprising a heating/cooling pipe; the heating/cooling module connecting with the boil and fermentation tank via the heating/cooling pipe; the fluid contained in the boil and fermentation tank can be heated or cooled to a predetermined temperature in order to create an environment with suitable temperature inside the boil and fermentation tank that is either suitable for fermentation or drinking of beer; and

a rapid fastener; the boil and fermentation tank being connected to the beer brewing device in a detachable manner by using the rapid fastener; therefore, the boil and fermentation tank is assembled within the beer brewing device in a replaceable manner;

wherein, the boil and

wherein, the boil and fermentation module can be individually detached and separated from the beer brewing device during the fermentation process or after the beer brewing process is completed, so as to connect another said boil and fermentation module with the beer brewing device for performing another said beer brewing process.

In a preferred embodiment:

the beer brewing device further comprises:

a mashing module, comprising a mashing tank and a receiving compartment located below the mashing tank; the mashing tank having an opening and being capable of performing a mashing process of the beer brewing process;

a cover module, comprising a cover; the cover is pivotally covered on the mashing module in an openable manner, in order to close or open the opening of the mashing tank; and

a pumping module, at least comprising a plurality of pipes and a plurality of valves and pumps located at the pipes; the pumping module is for connecting the mashing module, the cover module, the boil and fermentation module and the temperature control module, in order to pump at least a fluid to and between the mashing module and the boil and fermentation module;

the boil and fermentation tank can be connected under the mashing tank in a detachable manner by using the rapid fastener, such that the fluid inside the mashing tank can be drained to the boil and fermentation tank after the mashing process is completed;

an annular heater is furnished at the boil and fermentation tank for heating and boiling the liquid contained in the boil and fermentation tank in order to perform the boiling process;

an outlet end is located at a bottom of the mashing tank that is connectable with an opening end of the boil and fermentation tank, such that the fluid contained in the boil and fermentation tank can flow into the mashing tank through the opening end and the outlet end.

### BRIEF DESCRIPTION OF THE DRAWINGS

The present invention will now be specified with reference to its preferred embodiment illustrated in the drawings, in which:

FIG. 1 is a schematic view of the overall architecture of a preferred embodiment of the beer brewing device in accordance with the present invention;

FIG. 2A and FIG. 2B are the schematic diagrams of the brewing process of the beer brewing device shown in FIG. 1.

### DESCRIPTION OF THE PREFERRED EMBODIMENT

In order to more clearly disclose the beer brewing device and brewing process of the present invention, preferred embodiments will be described in detail below together with related drawings.

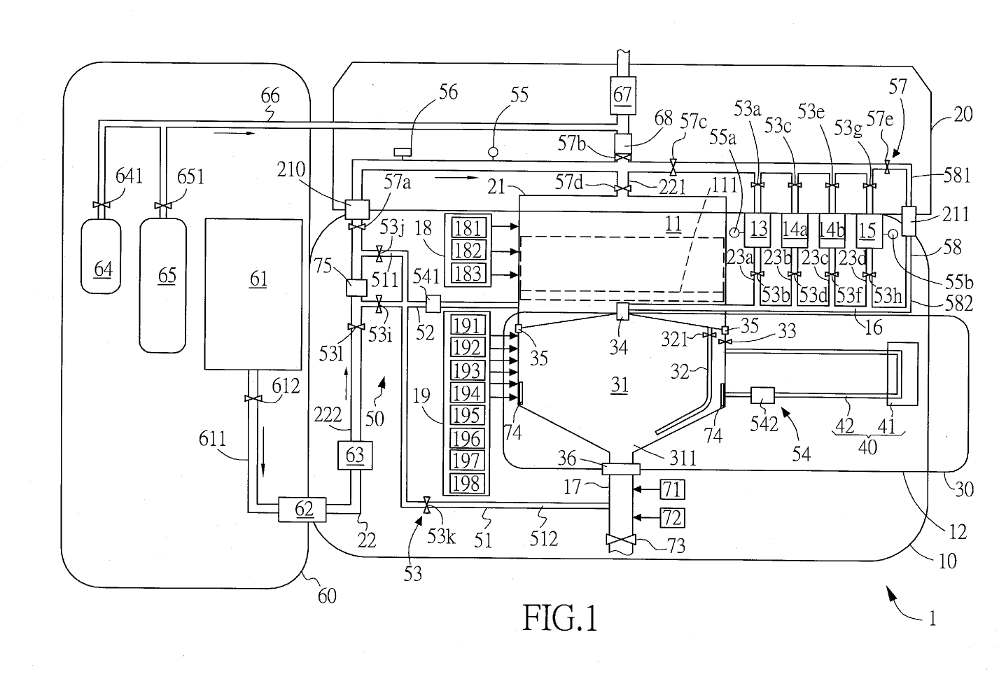

Please refer to FIG. 1, which is a schematic view of the overall architecture of a preferred embodiment of the beer brewing device in accordance with the present invention. The beer brewing device 1 of the present invention comprises: a mashing module 10, a cover module 20, a boil and fermentation module 30, a temperature control module 40, a pumping module 50 and a water tank module 60.

The mashing module 10 comprises a mashing tank 11, a receiving compartment 12, a yeast box 13, a first hops box 14a, a second hops box 14b, a sugar box 15, a second pipe 16, an outlet end 17, a first detecting module 18, and a second detecting module 19. The upper side of the mashing tank 11 is an opening for allowing at least one malted barley pack (not shown in figures) to be put into the mashing tank 11, in order to proceed with the mashing process of beer brewing. The outlet end 17 of the mashing module 10 is furnished with a color detector 71, a particle detector 72 and a drain valve 73.

In a preferred embodiment, the malted barley pack is the starch source for beer brewing and contains at least five kilograms of crushed malts. The yeast (not shown in figures) required in the fermentation process is placed in the yeast box 13. The first and second hops boxes 14a, 14b can be selectively input with suitable hops packs (not shown in figures) with different flavors. Suitable amount of sugar (not shown in figures) can be put in the sugar box 15. The mashing tank 11 is furnished with a basket-typed filter 111 for filtering the fluid (sweet wort) obtained from the malted barley pack after the mashing process. Although, in this preferred embodiment, the malted barley pack which contains at least five kilograms of crushed malts is used as the starch source for beer brewing, however, the starch source for beer brewing is not limited to this particular embodiment in the present invention. In fact, the quantity of starch source various according to different kinds of beer to be brewed, without a minimum or maximum limit of quantity; in addition, different kind of starches or crushed corns might also be added as the starch source for beer brewing.

The first detecting module 18 detects the related parameters inside the mashing tank 11, which includes: a pressure meter 181 for detecting the pressure, an upper level temperature meter 181 for detecting the temperature at a higher location of fluid, and a lower level temperature meter 182 for detecting the temperature at a lower location of fluid inside the mashing tank 11. The second detecting module 19 detects the related parameters inside the boil and fermentation tank 31 of boil and fermentation module 30, which includes: a bacteria meter 191 for detecting the amount of bacteria, an alcohol meter 192 for detecting the amount of alcohol, a bitterness meter 193 for detecting the level of bitter, a sweetness meter 194 for detecting the level of sweetness, a level instrument 195 for detecting the level of the boil and fermentation tank 31, a pressure meter 196 for detecting the pressure, an upper level temperature meter 197 for detecting the temperature at a higher location of fluid, and a lower level temperature meter 198 for detecting the temperature at a lower location of fluid inside the boil and fermentation tank 31.

The cover module 20 comprises a cover 21, a first pipe 22 and a plurality of sub-pipes 23a-23d. The cover 21 is pivotally connected to the mashing module 10 via a pivot 210, such that the opening of the mashing module 11 can be closed or opened by the cover 21. Wherein, one end 221 of the first pipe 22 is connected to an inlet of the mashing tank 11, while the other end of the first pipe 22 serves as an input end of water. When the sub-pipes 23a-23d are fastened to the mashing module 10 by using the first clamp 211 of the cover module 10, the first pipe 22 is connecting to the upper ends of all of the yeast box 13, first hops box 14a, second hops box 14b and sugar box 15; in addition, the sub-pipes 23a-23d are connected between the bottom ends of all of the yeast box 13, first hops box 14a, second hops box 14b and sugar box 15 and one end of the second pipe 16; and moreover, the other end of the second pipe 16 is connected to an inlet located at a top of the boil and fermentation tank 31. That is, the cover 21 of the cover module 20 is openable and pivotally connected to the mashing module 10 via the pivot 210; when the cover 21 is closed to fasten the mashing module 10, the cover 21 and the mashing tank 11 are sealed.

The boil and fermentation module 30 is installed in the receiving compartment 12 of the mashing module 10 in a detachable and replaceable manner. The boil and fermentation tank 31 can be connected to the lower side of the mashing tank 11 through a rapid fastener 34 and a ring-typed rapid fastener 35, and is also tightly fastened to the outlet end 17 by using the second clamp 36. The boil and fermentation module 30 comprises a boil and fermentation tank 31, a communication tube 32, and a one-way pressure valve 33. The boil and fermentation tank 31 is located right below the mashing tank 11. The bottom end of the boil and fermentation tank 31 is shaped like a funnel where an opening end 311 of the funnel-shaped bottom end of the boil and fermentation tank 31 is connected to the outlet end 17 of the mashing module 10. An annular heater 74 is furnished at the funnel-shaped bottom end of the boil and fermentation tank 31 for heating and boiling the liquid (e.g., sweet wort) contained in the boil and fermentation tank 31. When the boil and fermentation module 30 is received in the receiving compartment 12 of the mashing module 10, the communication tube 32 is connecting and communicating the mashing tank 11 and the boil and fermentation tank 31. There is a valve 321 furnished at the communication tube 32 for controlling the passage thereof, in order to control whether or not the filtered sweet wort (also referred as liquid) contained in the mashing tank 11 can be drained into the boil and fermentation tank 31 through the communication tube 32.

The one-way pressure valve 33 can exhaust the gas generated by the fermentation process of the sweet wort when the pressure inside the boil and fermentation tank 31 is higher than a predefined exhausting pressure of the one-way pressure valve 33, to avoid explosion of the boil and fermentation tank 31 due to over-high pressure. During the fermentation process of beer, the yeast will also precipitate to the bottom of the boil and fermentation tank 31 at the end of the fermentation. The particle detector 72 furnished at the outlet end 17 can detect the existence and concentration of the precipitates, such that the user can evacuate the precipitates (such as hops, yeast and proteins) from the boil and fermentation tank 31 through the drain valve 73 furnished at the bottom of the outlet end 17.

In a preferred embodiment, the temperature control module 40 is furnished on the boil and fermentation module 30, which comprises: at least one temperature controller (also referred as heating/cooling module) 41 and at least one temperature controlling pipe (also referred as heating/cooling pipe) 42. Wherein, the heating/cooling module 41 is furnished on a middle part of the heating/cooling pipe 42, while two ends of the heating/cooling pipe 42 are respectively connecting to an upper side and a lower side of the boil and fermentation tank 31. Therefore, the fluid (sweet wort or beer) in the boil and fermentation tank 31 can be pumped by the first pump 542 furnished on the heating/cooling pipe 42 to pass through and be heated or cooled by the heating/cooling module 41 in order to control and maintain the fluid within a predefined suitable temperature inside the boil and fermentation tank 31, so as to create an environment with the best temperature suitable for fermentation or drinking of the beer.

The pumping module 50 comprises at least a plurality of pipes and a plurality of valves 53 (including valves 53a-53k, 53l), a plurality of pumps 54 (including the mixing pump 541 and the first pump 542), a plurality of temperature meters 55, 55a, 55b, a flow meter 56, a plurality of air valves 57 (including the air valves 57a-57e) and an air sub-pipe 58 respectively furnished at predetermined suitable positions of these pipes. The mashing module 10, the cover module 20, the boil and fermentation module 30 and the temperature control module 40 are connected by these pipes and controlled by the valves 53a-53k, 53l of the pumping module 50, such that the fluid can be pumped between the mashing tank 11 and the boil and fermentation tank 31, and between the boil and fermentation tank 31 and the temperature control module 40 by the pumps 54 through the pipes. In this embodiment, the pipes include a third pipe 51 and a fourth pipe 52. The third pipe 51 connects to both the outlet end 17 and the first pipe 22, and the fourth pipe 52 connects to all of the mashing tank 11, the first pipe 22 and the third pipe 51. The valves 53, pumps 54, temperature meters 55, 55a, 55b and flow meter 56 are respectively furnished at predetermined positions of these pipes 22, 16, 51, 52 and sub-pipes 23a-23d. In the preferred embodiment of the present invention, the pumps 54 include the mixing pump 541 and the first pump 542; wherein, the mixing pump 541 is furnished at a predetermined location of the fourth pipe 52, while the first pump 542 is furnished at a predetermined location of the heating/cooling pipe 42. The third pipe 51 connects to both the outlet end 17 and the first pipe 22, while the fourth pipe 522 connects to all of the mashing tank 11, the first pipe 22 and the third pipe 51.

As shown in FIG. 1, the sub-pipes 23a-23d respectively connect to top sides of the yeast box 13, the first hops box 14a, the second hops box 14b and the sugar box 15. Each of the top side and the bottom side of the yeast box 13, the first hops box 14a, the second hops box 14b and the sugar box 15 is equipped with a valve 53a-53h to control the passage thereof. Both the yeast box 13 and the sugar box 15 is equipped with a temperature meter 55a, 55b respectively. The valve 53i is furnished at a predetermined location of the fourth pipe 52 between the mixing pump 541 and the first pipe 22, while the other two valves 53j, 53k are respectively furnished at predetermined locations of two ends 511, 512 of the third pipe 51.

In a preferred embodiment of the present invention, the outer surfaces of the mashing tank 11, the boil and fermentation tank 31, the yeast box 13, the sugar box 15, the first pipe 22 and the sub-pipes 23a-23d are covered with an insulator, a thermal barrier coating or a thermal insulation material (not shown in figures) in order to provide thermal insulating function.

The water tank module 60 comprises: a water tank 61, an oxygen tank 64 and a carbon dioxide tank 65. The water tank 61 is connected with the inlet end (front end) 222 of the first pipe 22 through the sixth pipe 611, the valve 612, the water filter 62 and the water pump 63. The valve 612 controls the passage of the sixth pipe 611, the water filter 612 filters the water passing through the sixth pipe 611, while the water pump 63 pumps the water from the water tank 61 to the inlet end 222 of the first pipe 22. The oxygen tank 54 and the carbon dioxide tank 65 are both connected with the first pipe 22 through the fifth pipe 66. The air pump 67 pumps air from the outside environment into the fifth pipe 66 and mix the outside air with the required oxygen (or carbon dioxide) provided by the oxygen tank 54 (or carbon dioxide tank 65). The mixed air and oxygen (or carbon dioxide) are then filtered by the air filter 68 and pumped into the mashing tank 11 and further into the boil and fermentation tank 31 for facilitating the fermentation processes (or increasing the carbon dioxide contained in the fermented beer). The valves 641, 651 are equipped at predetermined locations of the fifth pipe 66 connected to the oxygen tank 64 and the carbon dioxide tank 65 in order to control the output flows of the oxygen and the carbon dioxide respectively. In this embodiment, the water tank 61 has a capacity of at least 30L (30 liters) or more.

In a preferred embodiment of the present invention, the temperature control module 40 further comprises a heater 75. The heater 75 is furnished in the mashing module 10 at a location of the first pipe 22 near to the pivot 210 of the cover 21. The valve 53l, the heater 75, the flow meter 56 and the temperature meter 55 are all located at the first pipe 22 in order; wherein, the valve 53l is located at the inlet side of the heater 75, while the flow meter 56 and the temperature meter 55 are located at the outlet side of the heater 75. The heater 75 can heat the water coining from the water tank 61 of the water tank module 60 up to a predetermined temperature suitable for either the mashing process, the fermentation process or even the cleaning process before the water is pumped into the mashing tank 11 and/or further entering the boil and fermentation tank 31. The first pipe 22, the second pipe 16, the third pipe 51, the fourth pipe 52, the fifth pipe 44, the sixth pipe 611, the sub-pipes 23a-23d and the communication tube 32 are for transferring the water or sweet wort and are made of soft tubes with suitable stiffness.

Furthermore, the pumping module 50 comprises a plurality of air valves 57 (including the air valves 57a-57e) and an air sub-pipe 58. Wherein, the air valves 57a, 57b, 57c, 57d are respectively equipped at predetermined locations of the first pipe 22 near to the pivot 210, the fifth pipe 66 under the air filter 68 and above the first pipe 22 and the mashing tank 11, the first pipe 22 before front ends of the sub-pipes 23a-23d, and the outlet end 221 of the first pipe 22 above the mashing tank 31, in order to control passages of air (and oxygen or carbon dioxide). The first and second ends 581, 582 of the air sub-pipe 58 are respectively connected with the first pipe 22 and the second pipe 16. The valve 57e is located between the first end 581 of the air sub-pipe 58 and the first pipe 22. The air sub-pipe 58 can be used to supply (transfer) compressed air or mixed air to the boil and fermentation tank 31 through the second pipe 16 only when the cover 21 is tightly clamped with the mashing module 20.

In summary, the beer brewing device 1 of the present invention has the following breakthrough major advantages in terms of overall structure and technology:

high-temperature automatic cleaning and complete sterilization to the mashing tank, boil and fermentation tank and all pipes;

pressurized integrated mashing tank capable of performing multiple cyclic sparges of fermentable sweet wort;

integrated boil and fermentation tank for performing both the boiling process and the fermentation process within the same tank;

automatic detection and emission of precipitation by using particle detector;

integrated cyclic heating/cooling of fluid inside the boil and fermentation tank;

automatic cleaning of the mashing tank and the boil and fermentation tank, and automatic conversion of beer;

integrated tank for performing two fermentation processes in one single tank; and

fully automatic control of the fermentation processes by using detectors.

It is especially worth to mention that, each time when the boil and fermentation module 30 of the beer brewing device 1 of the present invention completes the first fermentation process, the second fermentation process and the beer brewing process, the boil and fermentation module 30 can be independently detached from the mashing module 10, in order to replace another boil and fermentation module 30 into the mashing module 10 for performing another beer brewing process, so as to increase the efficiency of beer brewing, simplify the beer brewing process, and decrease the labor costs, as well as to achieve the goal of fully automatic intelligent beer brewing device for batch production of beer. Moreover, the present invention also employs the novel process of the two fermentations in one single tank and reversed pouring of sweet wort, such that, during the whole process of beer brewing, human intervention is required only when putting in the required ingredients such as starch source, hops and yeast in the beginning of process and when the sparging step is completed and the starch source needs to be taken out. Except for the aforementioned two timings, other times of the beer brewing process is fully automatic operated by the beer brewing device 1, not only easy to use, but also ensures the stability of the wine quality.

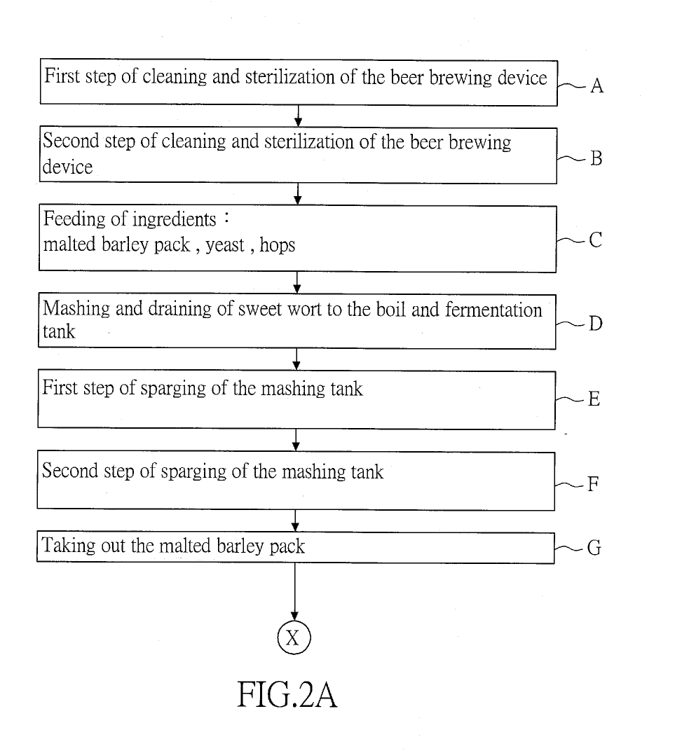

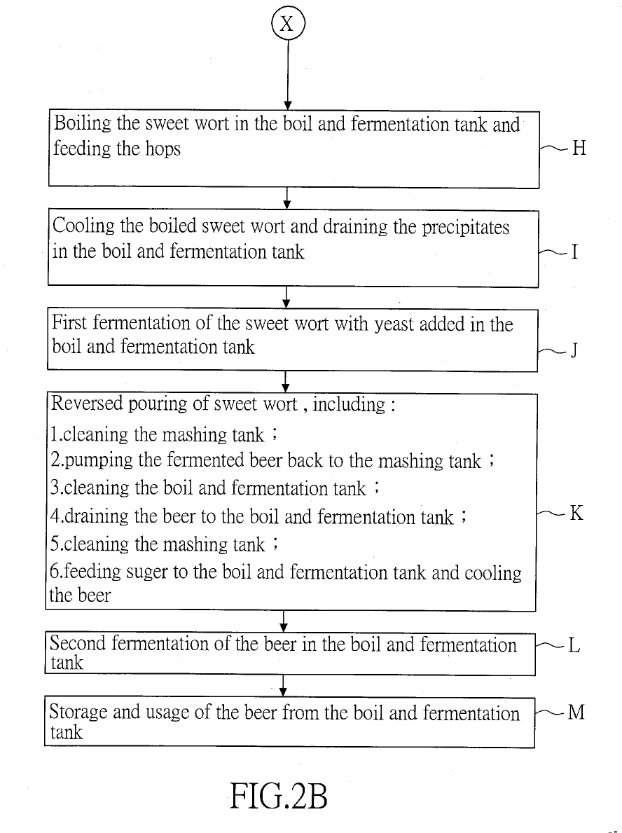

Please refer to FIG. 2A and FIG. 2B, which are the schematic diagrams of the brewing process of the beer brewing device shown in FIG. 1. In order to proceed with the beer brewing process as shown in FIG. 2A and FIG. 2B, the beer brewing device 1 illustrated above and shown in FIG. 1 must be provided. In a preferred embodiment of the present invention, the beer brewing process comprises the steps below.

Step (A): first step of cleaning and sterilizing of the beer brewing device 1. In this first step, the mashing tank 11, the boil and fermentation tank 31, and the first, third and fourth pipes 22, 51, 52 are continuously cyclic washed by using around 15L (fifteen liters) of hot water with at least 70° C. (better with 100° C. boiling water) and a flowing speed of around 1L/m for at least fifteen minutes. Generally speaking, in order to achieve the effect of cleaning and sterilizing, it can be cleaned either with hot water above 80° C. or warm water added with food grade germicide below 50° C. The flow speed and quantity of water mentioned here are merely suggested values, which are adjustable according to different conditions or durations of washing, and should not be used to limit the applicable scope of the present invention.

Step (B): second step of cleaning and sterilizing of the beer brewing device 1. In this second step, the yeast box 13, the first hops box 14a, the second hops box 14b, the sugar box 15, the second pipe 16 and the sub-pipes 23a-23d are continuously cyclic washed by using around 15L (fifteen liters) of hot water with at least 70° C. (better with 100° C. boiling water) and a flowing speed of around 1L/m for at least fifteen minutes. Similarly, warm water below 50° C. added with food grade germicide can also be used in washing, and the flow speed and quantity of water mentioned here are merely suggested values.

Step (C): feeding of ingredients. The ingredients such like the malted barley pack, yeast, hops and sugar are placed into their corresponding boxes respectively, which further includes the steps of:

opening the cover 21 and putting predetermined amount of the starch source (such like malted barley pack) into the mashing tank 11 of mashing module 10;

putting predetermined amount of the yeast into the yeast box 13;

putting at least one predetermined amount of hops into the first hops box 14a and/or second hops box 14b;

putting predetermined amount of sugar into the sugar box 15; and

closing up the cover 21 and fastening it to the mashing module 10.

Generally speaking, the amount of yeast and hops added, and whether or not to add the sugar, can be determined according to the desirable taste of the user. Except for the starch source, yeast and hops, the rest are not necessary ingredients.

Step (D): mashing and draining of sweet wort to the boil and fermentation tank. In this step, firstly, the pumping module 50 feeds water heated by the temperature control module 40 into the mashing tank 11. The water fed in the mashing tank 11 is heated and maintained at a first temperature for a first period of time in order to facilitate the mashing process. Wherein, the first temperature is ranged between 60° C. to 75° C. (better about 68° C.), and the first period of time is ranged between one to three hours (better about two hours). In addition, during the mashing process, the fluid inside the mashing tank 11 is pumped by the pumping module 50 to continuously cyclic flow through the temperature control module 40 in a flow speed of around 1L/m, such that the temperature of the fluid inside the mashing tank 11 can be maintained at the first temperature to proceed with the mashing process. After the mashing process is completed, the sweet wort (fluid) inside the mashing tank 11 is filtered by the basket-typed filter 111 and then drained to the boil and fermentation tank 31 via the communication tube 32. Generally speaking, the temperature for mashing process (i.e., the first temperature) can be ranged from low temperature to high temperature, any temperature lower than 70° C. can be used for mashing process. The mashing process can be performed by several stages with different temperature and duration of time, or by one signal temperature and duration of time, according to the adjustment made by the user. Accurate control of mashing temperature is the key to affect the reproducibility of beer brewing, that is, each batch of beer can be brewed with the same flavor and taste. However, even when the temperature and time duration vary in different batches, beer can still successfully brewed.

Step (E): first step of sparging of the mashing tank. In this step, a suitable amount of water heated and maintained at the first temperature is fed into the mashing tank 11, and then the mashing tank 11 is pressurized in order to filter and drain the fluid (mixture of the remaining wort and the newly added water) into the boil and fermentation tank 31, which is also called as “first sparging step”. In this embodiment, the first sparging step is performed by feeding around 5L (five liters) of hot water with around 70° C. and a flowing speed of around 1L/m into the mashing tank 11, and then pressurizing the mashing tank 11 in order to filter and drain the sweet wort of the second round into the boil and fermentation tank 31. In the present invention, the sparging steps described in steps (E) and (F) are optional, the purpose of doing so is to obtain as many sweet wort as possible in order to save the usage of malted barley. The water temperature and flow speed mentioned in steps (E) and (F) are merely suggestions. Generally speaking, the temperature of water used in the sparging steps is preferably higher than 70° C.

Step (F): second step of sparging of the mashing tank. In this step, a suitable amount of water heated and maintained at the first temperature is fed into the mashing tank 11 again, and then the mashing tank 11 is pressurized in order to filter and drain the fluid (mixture of the remaining wort and the newly added water) into the boil and fermentation tank 31, which is also called as “second sparging step”. Similarly, the second sparging step is also performed by feeding around 5L (five liters) of hot water with around 70° C. and a flowing speed of around 1L/m into the mashing tank 11, and then pressurizing the mashing tank 11 in order to filter and drain the sweet wort of the third round into the boil and fermentation tank 31.

Step (G): taking out the malted barley pack. In this step, the cover 12 is opened, then the malted barley pack (starch source) is taken out, and then the cover 21 is closed again. In the present invention, the timing to take out the malted barley pack (starch source) can be anytime after the sparging processes are completed and before the reversed pouring step (i.e., step (K)) begins. This is because that, the boiling and fermentation processes of the sweet wort are both performed inside the same boil and fermentation tank 31, and thus it is not hurry and yet not necessary to take out the malted barley pack (starch source) immediately after the sparging processes are completed.

Step (H): boiling the sweet wort in the boil and fermentation tank and feeding the hops. In this step, the fluid in the boil and fermentation tank 31 is heated to a second temperature for a second period of time, and the hops contained in at least one of the hops boxes 14a, 14b are added to the boil and fermentation tank 31 at a predetermined timing. Wherein, the second temperature is to boil the fluid which is around 100° C., and the second period of time is between one to three hours. In addition, the predetermined timing for adding the hops is during the second period of time. In an embodiment of this step, the sweet wort contained in the boil and fermentation tank 31 is about 20L (twenty liters) and is firstly boiled and kept at 100° C. for 1.5 hours, and then the hops of the first hops box are added, and then the sweet wort is boiled for 0.25 hour, and then the hops of the second hops box are added, and then the sweet wort is boiled for another 0.25 hour. Generally speaking, the boiling process is performed under normal atmospheric pressure at around 100° C., not only the wort can be completely sterilized, but also the protein can be solidified and separated. The duration for boiling the wort is usually between 1-3 hours in order to kill the germs and bacteria completely, but such boiling time can also be even longer. The hops can be added at anytime, even can be added right before drinking the beer. The amount, kinds and adding time of the hops can be adjusted according to the desirable taste of the user. The hops affect the bitterness and flavor/aroma of beer, in addition, the hops also have some sterilization and preservation effects.

Step (I): cooling the boiled sweet wort and draining the precipitates in the boil and fermentation tank. In this step, the fluid inside the boil and fermentation tank 31 is cooled down to a third temperature, and the precipitates and impurities precipitated at bottom of the fluid are drained out from the boil and fermentation tank 31. Wherein, the third temperature is between 22° C. to 35° C. In this embodiment, the fluid (boiled sweet wort) is cooled by the heating/cooling module 41 to around 26° C. In the meantime, the precipitates including hops, yeast and protein precipitated at the bottom of the boil and fermentation tank 31 are drained out via the drain valve 73. In the present invention, the third temperature is a range of temperature suitable for yeast to grow, different ranges of temperature should be chosen according to different kinds of yeast.

Step (J): first fermentation of the sweet wort with yeast added in the boil and fermentation tank. In this step, the yeast contained in the yeast box 13 is added into the boil and fermentation tank 31, and then, the sweet wort added with the yeast is maintained at the third temperature for a third period of time, in order to perform the first fermentation process. Wherein, the third period of time is ranged from 14 to 28 days, in addition, the gas (e.g., carbon dioxide) generated during the first fermentation process is discharged out of the boil and fermentation tank 31 via the one-way pressure valve 33. In an embodiment, the yeast of 26° C. is added, then the combination of the yeast and the sweet wort is evenly mixed in a cyclic manner for five minutes, and then the oxygen is added into the boil and fermentation tank 31 and the boil and fermentation tank 31 is heated (or cooled) to maintain at the third temperature about 26° C. for fermentation process for around 21 days. After 21 days later, the color detector 71 and particle detector 72 are used for separating the precipitated yeast and other precipitation. In the present invention, if two fermentation processes are applied in the beer brewing method, then the third period of time is around two weeks for the first fermentation process, and the purpose of the first fermentation process is to let the yeast to fully consume the sugar in the wort. During such first fermentation process, the gas will be one-way discharged. However, if only one single fermentation process is performed in the beer brewing method of the present invention, then the time for brewing the beer can be saved; in the meantime, the gas (carbon dioxide) is retained inside the boil and fermentation tank. The fermented beer is still drinkable even the duration of the single fermentation process (i.e., the third period of time) is only one or two weeks, and the fermented beer drain out from the boil and fermentation tank should better be filtered before drinking Moreover, the step to add the oxygen is optional, but not a necessary step. The precipitated yeast and other precipitation can be separated by using the particle detector 72 only, in addition, the purpose of the color detector 71 is for detecting the color of beer as a reference for the user.

Step (K): reversed pouring of sweet wort. In this step, the fluid (semi-finished beer) in the boil and fermentation tank 31 is pumped back to the mashing tank 11, and then filtered and drained again to the boil and fermentation tank 31 for performing the second fermentation process. The reversed pouring process of Step (K) further includes the following steps:

1. cleaning the mashing tank 11 with hot water; in order to achieve the effect of cleaning and sterilizing, the mashing tank 11 is washed and cleaned by using either hot water above 80° C. or warm water added with food grade germicide below 50° C.;

2. pumping the first fermented fluid (semi-finished beer) contained in the boil and fermentation tank 31 back to the mashing tank 11 by using the pumping module;

3. cleaning the boil and fermentation tank 31 with hot water; in order to achieve the effect of cleaning and sterilizing, the boil and fermentation tank 31 is washed and cleaned by using either hot water above 80° C. or warm water added with food grade germicide below 50° C.;

4. draining the fluid (semi-finished beer) contained in the mashing tank 11 to the cleaned boil and fermentation tank 31 again; the fluid is filtered by the basket-typed filter 111 when draining;

5. cleaning the mashing tank 11 with hot water again; and

6. feeding sugar to the boil and fermentation tank 31, and cooling the fluid (semi-finished beer) contained in the boil and fermentation tank 31 to the third temperature (e.g., 26° C.) and staying for ten minutes; generally speaking, additional sugar should be added into the boil and fermentation tank 31 now in order to allow the beer to ferment again as well as to retain the gas (carbon dioxide) generated during the second fermentation process, so as to enrich the taste of beer; the sugar added can be granulated pure sugar or other sterilized malted barley water; the temperature control of the third temperature is based on the kind of yeast existed in the fluid (semi-finished beer), that is, the temperature of newly added sterilized malted barley water should be the same as the fluid (semi-finished beer) contained in the boil and fermentation tank 31.

Step (L): second fermentation of the beer in the boil and fermentation tank 31. In this step, the fluid (semi-finished beer) is maintained at the third temperature for a fourth period of time, in order to perform the second fermentation process. Wherein, the fourth period of time is ranged from 4 to 10 days. In the meantime, the one-way pressure valve 33 is closed such that the gas (e.g., carbon dioxide) generated during the second fermentation process is retained inside the boil and fermentation tank 31 and is partially dissolved in the fluid. After the second fermentation process is completed, the fluid contained in the boil and fermentation tank 31 will become the finished and drinkable beer. In an embodiment, fluid inside the boil and fermentation tank 31 is maintained at 26° C. for around seven days. Generally speaking, beer can be brewed by using single or two fermentation processes. The second fermentation process is for retaining the gas of beer. The first fermentation process takes around one or two weeks and can consume almost all sugar in the wort. After the first fermentation process, the fermentation of beer is almost completed, the beer is drinkable, and there is a few gas dissolved in the beer, only that the taste of beer in this stage might not be as stimulating as other ordinary beers due to fewer gas dissolved in beer. The second fermentation process takes around one or two weeks to complete. Most yeasts start to rest because there is no sufficient sugar left in the beer. The taste and flavor of beer is almost stable and consistent. However, as long as the beer is not sterilized, the yeast contained therein will keep alive after two weeks when the second fermentation process is completed. Such kind of beer will be better and more special in flavor and taste after half a year or one year later.

Step (M): storage and usage of the beer from the boil and fermentation tank. In the present invention, after the second fermentation process is completed, the boil and fermentation module 30 itself can directly act as the container for storing and cooling the beer. The fluid (finished beer) contained in the boil and fermentation tank 31 can be cooled by the heating/cooling module 41 to a cold temperature (such like 4° C.) and thus is ready for instant usage and drinking by the user.

In this embodiment, when Step (I) is completed, the boil and fermentation module 30 can be detached and separated from the mashing module 10, in order to allow the boil and fermentation module 30 itself to proceed with the first fermentation process illustrated in Step (J). In addition, when Step (K) is completed, the boil and fermentation module 30 can also be detached and separated from the mashing module 10, in order to allow the boil and fermentation module 30 itself to proceed with the second fermentation process illustrated in Step (L). Thereby, when one boil and fermentation module 30 is detached from the mashing module 10 for performing either the first or second fermentation process, another boil and fermentation module 30 can be inserted into the mashing module 10 for performing another beer brewing process.

In summary, in the beer brewing device 1 of the present invention and the brewing process thereof, the boil and fermentation module 30 can be individually detached and separated from the receiving compartment 12 of the mashing module 10 when the fermentation processes are in progress or after the entire brewing process is complete, such that another boil and fermentation module 30 can be inserted and assembled with the mashing module 10 for performing another new batch of beer brewing process. The boil and fermentation module 30 itself can directly act as the container for storing and cooling the beer, such that the boil and fermentation module 30 can be transported directly to a restaurant or a customer for their usage. In addition, the batch-completed beer can also be directed to another boil and fermentation tank 31 of another boil and fermentation module 30 connected in series, such that the beer brewing device can continue to work on the next batch of brewing beer. By using the integrated structural design of the mashing tank 11 and the boil and fermentation tank 31, and using the pressurized air and gravity to cyclic sparging and filtering the sweet wort, as well as using the integrated brewing process, the overall volume of the beer brewing device can be decreased. In addition, the particle detector 72 is used for automatic detecting and draining the precipitates via the drain valve 73. All tanks, pipes and sub-pipes can be automatically cleaned and sterilized by using cyclic hot water. Moreover, the parameters of the beer brewing process can be monitored and controlled by using the pressure meters 181, 196, temperature meters 182, 183, 197, 198, color detector 72, bacteria meter 191, sweetness meter 194, bitterness meter 193 and alcohol meter 192 of the first and second detecting module 18, 19, so as to monitor the ingredients of beer in a real-time manner and maintain a stable quality of brewed beer. Furthermore, the novel reverse pouring process is employed to pump the beer back to the mashing tank and also clean the tanks and pipes with hot water, such that the boil and fermentation module can be used for the second fermentation process. The beer brewing device of the present invention provides the features of integrated beer brewing process and fully automatic control and production technologies, not only simplifies the cumbersome brewing processes, saves the labor cost, but also improves the flavor and taste of beer with two fermentation processes.

While the present invention has been particularly shown and described with reference to a preferred embodiment, it will be understood by those skilled in the art that various changes in form and detail may be without departing from the spirit and scope of the present invention.

What is claimed is:

1. A beer brewing device for performing a beer brewing process, said beer brewing device comprising:
a mashing module, comprising a mashing tank and a receiving compartment located below the mashing tank; the mashing tank having an opening and being capable of performing a mashing process of the beer brewing process;
a cover module, comprising a cover; the cover is pivotally covered on the mashing module in an openable manner, in order to close or open the opening of the mashing tank;
a boil and fermentation module, comprising a boil and fermentation tank connectable with the mashing tank; the boil and fermentation tank being capable of performing a boiling process and at least one fermentation process of the beer brewing process;
a temperature control module, connecting to the mashing module and the boil and fermentation module; the temperature control module comprising: at least one temperature controller and at least one at least one temperature controlling pipe; the at least one temperature controller being connected with the mashing tank and the boil and fermentation tank via the at least one temperature controlling pipe, in order to control a mashing temperature of the mashing process performed in the mashing tank, a boiling temperature of the boiling process performed in the boil and fermentation tank, and a fermentation temperature of the fermentation process performed in the same boil and fermentation tank; and
a pumping module, at least comprising a plurality of pipes and a plurality of valves and pumps located at the pipes; the pumping module is for connecting the mashing module, the cover module, the boil and fermentation module and the temperature control module, in order to pump at least a fluid to and between the mashing module and the boil and fermentation module.

2. The beer brewing device of claim 1, wherein:
the boil and fermentation module is received in the receiving compartment of the mashing module in a detachable and replaceable manner; wherein, the boil and fermentation module can be individually detached and separated from the receiving compartment of the mashing module during the fermentation process or after the beer brewing process is completed, so as to insert another said boil and fermentation module into the receiving compartment of the mashing module for performing another said beer brewing process;
the mashing module further comprises: a yeast box, at least one hops box and a sugar box for containing yeast, hops and sugar required in the beer brewing process; a starch source can be put into the mashing tank through the opening;
an outlet end is located at a bottom of the mashing tank that is connectable with an opening end of the boil and fermentation tank, such that the fluid contained in the boil and fermentation tank can flow into the mashing tank through the opening end and the outlet end;
said at least one fermentation process comprises a first fermentation process and a second fermentation process;
said pipes of the pumping module comprises a first pipe and a second pipe; the first pipe connects with the mashing tank and upper ends of the yeast box, the at least one hops box, and the sugar box via the cover module; the second pipe at least connects with the boil and fermentation tank and bottom ends of the yeast box, the at least one hops box and the sugar box; by using the valves and the pumps, the fluid contained in the mashing tank can be drained to the boil and fermentation tank when the mashing process is completed, in addition, at least one of the yeast, hops and sugar can be fed into the boil and fermentation tank for performing either the boil process or the fermentation process;
said pipes of the pumping module further comprises a third pipe and a fourth pipe; the third pipe connects with the outlet end of the mashing module and the first pipe; the fourth pipe connects with the mashing tank, the first pipe and the third pipe; by using the valves and the pumps, the fluid contained in the boil and fermentation tank can be pumped back to the mashing tank when the first fermentation process is completed, and then, hot water can be fed to the boil and fermentation tank via the first pipe and the fourth pipe in order to perform a cleaning process, and then, the fluid contained in the mashing tank can once again be drained to the boil and fermentation tank for performing the second fermentation process.

3. The beer brewing device of claim 2, further comprising a water tank module; wherein, the water tank module comprises: a water tank, an oxygen tank and a carbon dioxide tank; the water tank is connected with the first pipe through a sixth pipe; the oxygen tank and the carbon dioxide tank are connected with the first pipe via a fifth pipe; oxygen contained in the oxygen tank and carbon dioxide contained in the carbon dioxide tank can be fed into the boil and fermentation tank via the mashing tank.

4. The beer brewing device of claim 3, wherein:
the temperature controller is a heating/cooling module; the starch source includes a malted barley pack containing crushed malts;
the outlet end of the mashing module is equipped with a color detector, a particle detector and a drain valve; in addition, the pumping module further comprises: a plurality of sub-pipes, a plurality of temperature meters and at least one flow meter; wherein, the valves, the pumps, the temperature meters and the flow meter are equipped at predetermined locations of the pipes and sub-pipes respectively;
the mashing module further comprises a first detecting module and a second detecting module; wherein, the first detecting module comprises a first pressure meter, a first upper level temperature meter and a first lower level temperature meter for detecting the pressure and temperature inside the mashing tank respectively; the second detecting module comprises a bacteria meter, an alcohol meter, a bitterness meter, a sweetness meter, a level instrument, a second pressure meter, a second upper level temperature meter and a second lower level temperature meter for detecting related parameters inside the boil and fermentation tank;
a filter is equipped in the mashing tank;
an annular heater is equipped in the boil and fermentation tank;
the boil and fermentation module further comprises a one-way pressure valve for discharging carbon dioxide generated during the first fermentation process; the one-way pressure valve is closed during the second fermentation process so as to retain the carbon dioxide generated during the second fermentation process inside the boil and fermentation module.

5. The beer brewing device of claim 4, wherein:
the pumps of the pumping module includes a mixing pump and a first pump; wherein, the mixing pump is located at the fourth pipe, while the first pump is located at the temperature controlling pipe;
the temperature control module further comprises a heater located at the first pipe;
the boil and fermentation module further comprises a communication tube for connecting between the mashing tank and the boil and fermentation tank; the communication tube is equipped with a valve;
the pumping module further comprises: a plurality of air valves and an air sub-pipe; wherein, the air valves are respectively located at predetermined locations of the first pipe and the fifth pipe in order to control passages of air, oxygen and/or carbon dioxide; the air sub-pipe are connected with the first pipe and the second pipe; the air sub-pipe can be used to supply compressed air or mixed air to the boil and fermentation tank through the second pipe only when the cover is tightly clamped with the mashing module.

6. The beer brewing device of claim 2, wherein:
the cover can be tightly clamped with the mashing module by using a first clamp; the boil and fermentation module can be tightly fastened to the outlet end by using a second clamp so as to be received within the receiving compartment of the mashing module;
the boil and fermentation tank is located under the mashing tank and can be connected to the mashing tank in a detachable manner by using a rapid fastener.

7. A beer brewing process of a beer brewing device, comprising steps of:
Step (1): providing a beer brewing device; the beer brewing device comprising a mashing module, a cover module, a boil and fermentation module, a temperature control module and a pumping module; the cover module covering the mashing module; the mashing module comprising a mashing tank; the boil and fermentation module comprising a boil and fermentation tank connectable with the mashing tank; the temperature control module being connected with the boil and fermentation module for controlling temperature;
Step (2): feeding of ingredients; the ingredients comprising a malted barley pack, a yeast, hops and sugar are placed into a plurality of boxes of the beer brewing device respectively;
Step (3): mashing and draining of sweet wort to the boil and fermentation tank; firstly, the pumping module feeding water heated by the temperature control module into the mashing tank; the water in the mashing tank being heated and maintained at a first temperature for a first period of time in order to facilitate a mashing process so as to generate the sweet wort; after the mashing process being completed, the sweet wort inside the mashing tank being filtered and drained to the boil and fermentation tank;
Step (4): boiling the sweet wort in the boil and fermentation tank and feeding the hops; the fluid in the boil and fermentation tank being heated to a second temperature for a second period of time, and the hops are added to the boil and fermentation tank at a predetermined timing; the second temperature is for boiling the sweet wort;
Step (5): cooling the boiled sweet wort and draining precipitates in the boil and fermentation tank; the boiled sweet wort inside the boil and fermentation tank being cooled down to a third temperature, and precipitates precipitated at bottom of the sweet wort being drained out from the boil and fermentation tank;
Step (6): first fermentation of the sweet wort with yeast added in the boil and fermentation tank; the yeast being added into the boil and fermentation tank, and then, the sweet wort added with the yeast being maintained at the third temperature for a third period of time, in order to perform a first fermentation process;
Step (7): reversed pouring of sweet wort; said Step (7) further comprising the following Step (7.1) to Step (7.5):
Step (7.1): cleaning the mashing tank with hot water;
Step (7.2): pumping the sweet wort contained in the boil and fermentation tank back to the mashing tank by using the pumping module;
Step (7.3): cleaning the boil and fermentation tank with hot water;
Step (7.4): draining the sweet wort contained in the mashing tank to the cleaned boil and fermentation tank;
Step (7.5): cooling the sweet wort contained in the boil and fermentation tank to the third temperature;
Step (8): second fermentation of the sweet wort in the boil and fermentation tank; the f sweet wort being maintained at the third temperature for a fourth period of time, in order to perform a second fermentation process; carbon dioxide generated during the second fermentation process being retained inside the boil and fermentation tank; after the second fermentation process being completed, fluid contained in the boil and fermentation tank becomes drinkable beer.

8. The beer brewing process of claim 7, wherein:
in the Step (2), sugar is placed in one of the boxes;
in the Step (3), the first temperature is between 60° C. to 75° C., and the first period of time is ranged between one to three hours; in addition, during the mashing process, fluid inside the mashing tank is pumped by the pumping module to continuously cyclic flow through the temperature control module, such that the temperature of the fluid inside the mashing tank can be maintained at the first temperature to proceed with the mashing process;
in the Step (4), the second temperature is around 100° C., the second period of time is between one to three hours, the predetermined timing for adding the hops is during the second period of time;
in the Step (5), the third temperature is between 22° C. to 35° C.;
in the Step (6), the third period of time is ranged from 14 to 28 days; in addition, the carbon dioxide generated during the first fermentation process is discharged out of the boil and fermentation tank via an one-way pressure valve;
in the Step (7), temperature of said hot water for cleaning is over 70° C.;
in the Step (7.5), the sugar is added to the boil and fermentation tank;
in the Step (8), the fourth period of time is ranged from 4 to 10 days.

9. The beer brewing process of claim 7, wherein:
a step for cleaning and sterilizing of the beer brewing device is included between the Step (1) and the Step (2) in order to clean and sterilize the mashing tank, the boil and fermentation tank, the boxes and a plurality of pipes of the pumping module;
a sparging step is included between the Step (3) and the Step (3) in order to feed a suitable amount of water at the first temperature into the mashing tank, and then the mashing tank is pressurized to drain the fluid into the boil and fermentation tank; wherein, the malted barley pack can be taken out of the mashing tank at anytime after the sparging process is completed and before the reversed pouring step (i.e., step (7)) begins.

10. The beer brewing process of claim 7, wherein, the boil and fermentation module is connected to a receiving compartment of the mashing module in a detachable and replaceable manner; the boil and fermentation module can be detached and separated from the mashing module after the Step (5) is completed such that the boil and fermentation module can individually perform the first fermentation process of the Step (6); in addition, the boil and fermentation module can also be detached and separated from the mashing module after the Step (7) is completed such that the boil and fermentation module can individually perform the second fermentation process of the Step (8); therefore, when one said boil and fermentation module is separated from the mashing module for individually performing the fermentation process, another said boil and fermentation module can be connected to the mashing module for performing another said beer brewing process.

11. A boil and fermentation module of a beer brewing device, the beer brewing device being for performing a beer brewing process; said boil and fermentation module comprising:
a boil and fermentation tank; said boil and fermentation tank being capable of containing a fluid for performing a boiling process and at least one fermentation process of the beer brewing process;
a temperature control module, connecting to the boil and fermentation tank and comprising: at least one temperature controller and at least one temperature controlling pipe; the temperature controller comprising a heating/cooling module; the temperature controlling pipe comprising a heating/cooling pipe; the heating/cooling module connecting with the boil and fermentation tank via the heating/cooling pipe; the fluid contained in the boil and fermentation tank can be heated or cooled to a predetermined temperature in order to create an environment with suitable temperature inside the boil and fermentation tank that is either suitable for fermentation or drinking of beer; and
a rapid fastener; the boil and fermentation tank being connected to the beer brewing device in a detachable manner by using the rapid fastener;
therefore, the boil and fermentation tank is assembled within the beer brewing device in a replaceable manner;
wherein, the boil and wherein, the boil and fermentation module can be individually detached and separated from the beer brewing device during the fermentation process or after the beer brewing process is completed, so as to connect another said boil and fermentation module with the beer brewing device for performing another said beer brewing process.

12. The boil and fermentation module of claim 11, wherein
the beer brewing device further comprises:
a mashing module, comprising a mashing tank and a receiving compartment located below the mashing tank; the mashing tank having an opening and being capable of performing a mashing process of the beer brewing process;
a cover module, comprising a cover; the cover is pivotally covered on the mashing module in an openable manner, in order to close or open the opening of the mashing tank; and
a pumping module, at least comprising a plurality of pipes and a plurality of valves and pumps located at the pipes; the pumping module is for connecting the mashing module, the cover module, the boil and fermentation module and the temperature control module, in order to pump at least a fluid to and between the mashing module and the boil and fermentation module;
the boil and fermentation tank can be connected under the mashing tank in a detachable manner by using the rapid fastener, such that the fluid inside the mashing tank can be drained to the boil and fermentation tank after the mashing process is completed;
an annular heater is furnished at the boil and fermentation tank for heating and boiling the liquid contained in the boil and fermentation tank in order to perform the boiling process;
an outlet end is located at a bottom of the mashing tank that is connectable with an opening end of the boil and fermentation tank, such that the fluid contained in the boil and fermentation tank can flow into the mashing tank through the opening end and the outlet end.
